(19) United States
(12) Patent Application Publication
(10) Pub. No.: US 2015/0186825 A1
(43) Pub. Date: Jul. 2, 2015

(54) Cost and Profitability Planning System

(71) Applicants: Suresh Balasubramhanya, Fremont, CA (US); Huned Botee, San Francisco, CA (US); Joe Kuo, Redwood City, CA (US); Matthew Shore, Belmont, CA (US)

(72) Inventors: Suresh Balasubramhanya, Fremont, CA (US); Huned Botee, San Francisco, CA (US); Joe Kuo, Redwood City, CA (US); Matthew Shore, Belmont, CA (US)

(21) Appl. No.: 14/333,493

(22) Filed: Jul. 16, 2014

Related U.S. Application Data
(60) Provisional application No. 61/922,013, filed on Dec. 30, 2013.

(51) Int. Cl. G06Q 10/06; G06F 17/50

(52) U.S. Cl. CPC G06Q 10/06315; G06Q 10/067; G06F 17/5009

(57) ABSTRACT

Implementations generally relate to cost and profitability planning. In some implementations, a method includes constructing a graph data structure based on supply chain information and financial information. The method also includes computing cost information and profitability information based on the graph data structure. The method also includes generating a grid model from the cost information and the profitability information, where the grid model includes measures that are associated with dimension members arranged in hierarchies.

### CROSS REFERENCE TO RELATED APPLICATIONS

This application claims priority to U.S. Provisional Application No. 61/922,013, filed Dec. 30, 2013. Application No. 61/922,013 is hereby incorporated by reference in its entirety.

### BACKGROUND

Companies typically manage costs and strive to improve margins. Doing so is especially relevant for companies with large cost of goods sold (COGS) line items, where revenue minus COGS equals gross margin. Typical examples include high-tech manufacturing companies, consumer packaged goods manufacturing companies, and automotive/aerospace manufacturing companies. For these types of companies, much of the cost sits below the finished good (e.g., a mobile phone) in the form of raw materials and components (e.g., memory chips used in the mobile phone), assembly and test processes, and direct labor. Cost and margin management consists of several different business processes. A prototypical example is the calculation of fully-burdened product costs. A fully-burdened product cost is a cost metric that includes all cost components. For example, such cost components may include raw materials, cost to manufacture, assemble, package and test, direct and indirect labor, depreciation, etc.

### SUMMARY

Implementations generally relate to cost and profitability planning. In some implementations, a method includes constructing a graph data structure based on supply chain information and financial information. The method also includes calculating cost information and profitability information based on the graph data structure. The method also includes generating a grid model from the cost information and the profitability information, where the grid model includes measures that are associated with dimension members arranged in hierarchies.

### BRIEF DESCRIPTION OF THE DRAWINGS AND ADDENDA

FIG. 1 illustrates a block diagram of an example environment, which may be used to implement the implementations described herein.

FIG. 2 illustrates an example simplified flow diagram for facilitating cost and profitability planning, according to some implementations.

FIG. 3 illustrates an example simplified flow diagram for generating a grid model from a graph data structure, according to some implementations.

FIG. 4 illustrates an example graph representing a dimension hierarchy, where the graph shows component hierarchy members, according to some implementations.

FIG. 5 illustrates an example bill of materials (BOM) rendered as a table, according to some implementations.

FIG. 6 illustrates an example BOM, rendered as a graph, according to some implementations.

FIG. 7 illustrates example BOMs, rendered as graphs, according to some implementations.

FIG. 8 illustrates an example graph representing a BOM with a dimension hierarchy projected onto it, according to some implementations.

FIG. 9 illustrates example graph revisions, according to some implementations.

FIG. 10 illustrates an example BOM table, according to some implementations.

FIG. 11 illustrates an example material master table, according to some implementations.

FIG. 12 illustrates an example grid structure, according to some implementations.

FIG. 13 illustrates a block diagram of an example server device, which may be used to implement the implementations described herein.

### DETAILED DESCRIPTION

Implementations generally relate to cost and profitability planning. In various implementations, a system constructs a graph data structure based on supply chain information, which may include bill of materials (BOM) information, map representing supply chain, and financial information. The system also computes cost information (e.g., cost information derived from supply chain information) and profitability information based on the graph data structure. The system also generates a grid model from the cost information and the profitability information, where the grid model includes measures (e.g., dollar amounts, units sold) that are associated with dimension members (e.g., months as members of a time dimension, or states as members of a geographical area dimension) arranged in hierarchies. The grid model is thereby derived from the graph data structure in addition to dimension hierarchies. In some implementations the grid model structure may involve a spreadsheet, as will be described below. The grid model can in some implementations be obtained through a graph to grid transformation, by transforming information captured in graph form into an intermediate form, a table indexed by the columns in the grid, then finally pivoting it into the grid.

As described in more detail below, the system allocates external costs to one or more nodes along one or more dimensions in the grid model. The system also efficiently performs calculations relating to the implementations in the context of interactive planning tasks.

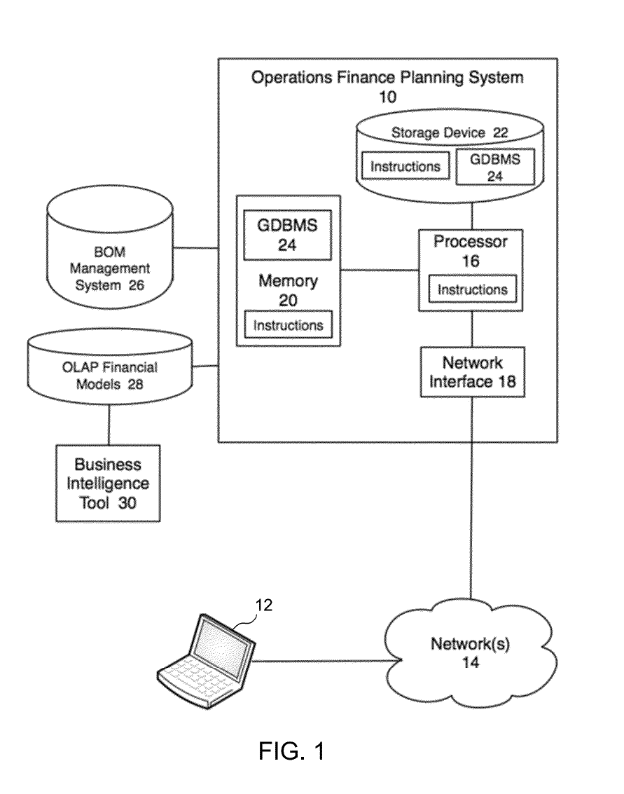

FIG. 1 illustrates a block diagram of an example environment, which may be used to implement the implementations described herein. In some implementations, cost and profitability planning system, or system 10, is configured as a server, accessible by one or more clients 12 over one or more networks 14.

While system 10 is labeled an operations finance planning system 10, system 10 and implementations described herein may apply to a variety of areas. For example, implementations may apply to operations finance planning. Implementations may apply to cost accounting, including standard cost generation and variance analysis. Implementations may apply to financial planning, including financial statement generation and profitability analysis. Implementations may apply to procurement, including supplier share of business modeling and hedging strategy development.

Implementations may also apply to product development and engineering, where product developers and engineers may want to develop cost models early in the life cycle of a product. Implementations may also apply to various corporate finance analyses, where analysts may want to model profitability. Moreover, implementations may also apply to product launches, where operations finance analysts monitor costs.

In some instances, network(s) 14 may include one or more enterprise networks and/or networks of networks, such as the Internet. System 10 may be instantiated within an enterprise, e.g., as a dedicated system for an enterprise hosted on one or more servers, or as software as a service accessible by multiple different customers. In the latter instance, each customer may be provided a separate instantiation of the software and hardware that comprises one embodiment of system 10 or, in other cases, different customers may share a single instantiation of such software on one or more hardware platforms with their own data being kept separate from one another. The software that comprises one embodiment of system 10 may be executed on one or more virtual machines that run on various hardware platforms.

In the example illustrated in FIG. 1, a processor 16 may control the overall functions of system 10, such as running applications and controlling accesses to remote databases and systems. Such a processor may be any type of processor and may communicate with client 12 over network(s) 14 through a network interface 18. The processor may use short-term memory 20 to store operating instructions and to help in the execution of the operating instructions (e.g., such as the temporary storage of calculations and the like). The processor may also use non-transitory storage device 22 to store and read instructions, files, and other data that requires long term, non-volatile storage. Graph database management system (GDBMS) 24 may likewise be stored in storage device 22 and loaded into memory 20 as and when needed. The processor 16 may communicate with a remote BOM management system 26 or database in order to populate GDBMS 24. Further, the processor may access online analytical processing (OLAP) style financial models 28 produced by a remote business intelligence tool 30. In some cases, these communications may take place over network(s) 14 or over dedicated communication paths. The processor 16 may be temporarily configured (e.g., by computer-executable instructions read from memory 20 and/or storage device 22) to perform the relevant operations of example methods described herein. Thus, memory 20 may be any form of memory, such as a random access memory (RAM) or other dynamic storage device, for storing information and instructions to be executed by processor 16. Memory 20 also may be used for storing temporary variables or other intermediate information during execution of instructions to be executed by processor 16. Although not shown, system 10 may include a read only memory (ROM) or other static storage device for storing static information and instructions for the processor 16. Storage device 22 may have a machine readable storage medium (such as a hard disk) for storing information and instructions.

In various implementations, processor 16 executes sequences of instructions contained in memory 20. Such instructions may be read into memory 20 from another computer-readable medium, such as storage device 22. Execution of the sequences of instructions contained in the memory 20 causes the processor 16 to perform the process steps described herein to effect the various computations and provide the various user interface screens displaying information derived from said computations to client 12. The computer program(s) pursuant to which processor 16 performs these actions may be written in any form of programming language, including compiled or interpreted languages, and may be deployed in any form, including as a stand-alone program or as a module, subroutine, or other unit suitable for use in a computing environment. Although system 10 is illustrated as a single computing entity, in various instantiations it may exist as computer software executed on multiple computers at one site or distributed across multiple sites and interconnected by a communication network. Such computer systems, when executing this software are configured as special purpose machines to perform the functions described herein.

While processor 16 of system 10 may be used to perform the steps as described in the implementations described herein, any suitable component or combination of components of system 10 or any suitable processor or processors associated with system 10 or any suitable system may perform the steps described.

In various implementations described herein, a software application stored in a memory or computer-readable storage medium provides instructions that enable a processor to perform these functions and other functions described herein.

The following introduces various concepts and applications associated with implementations described herein. All enterprises involved in the manufacture and sale of goods or provisions of services have costs associated with those business activities. Especially in the case of manufacturers, many of these costs can be grouped into categories such as raw materials, components, assembly and test activities, and direct labor. These costs are example costs associated with supply chain information.

In various implementations, cost information regarding supply chain activities may include costs for transforming natural resources, raw materials, and components into a finished product that is delivered to the end customer. In some implementations, the supply chain information may include a map that represents a supply chain.

As described in more detail below, in various implementations, supply chain information may include and/or may be modeled as allocated items of a BOM for a finished good. As such, a BOM may represent a list of all components, parts, ingredients, and/or materials needed to make a given item. Such costs may be referred to as component costs. Hereinafter, many aspects of supply chain information will be illustrated by a BOM example. While some implementations are illustrated in the context of BOM information, some of these implementations and others may also apply to other types of supply chain information.

In various implementations, the total cost of a given part consists of one or more partial costs. In some implementations, partial costs may include component costs rolled up along the BOM. Such rolled up costs are costs that can be directly attributed to the given parts. Materials are examples.

In some implementations, partial costs may include allocated costs which are split among all or some finished goods using an allocation function (e.g., split cost of facilities as a function of the volume of each finished good produced there). Allocated costs such as facilities costs typically cannot be directly attributed to a given part.

In some implementations, partial costs may include local costs which are incurred just at the particular point in the process. An example of a local cost is the unit cost of a part, if the part is purchased or if there is a labor cost to assemble subcomponents or of there is a time cost to put the part onto a testing machine.

The final cost associated with the finished good is often referred to as the fully-burdened product cost. For example, the fully-burdened product cost accounts for all cost components thereof (e.g., raw materials, costs to manufacture, assemble, package and test, direct and indirect labor, depreciation, etc.).

The fully-burdened product cost metric is important for a variety of reasons. For example, when coupled with a selling price, the fully-burdened product cost represents a vehicle to assess the profitability of a product. If the same product is made in multiple plants, a fully-burdened product cost provides management with a way to evaluate relative plant efficiency. Thus, understanding the fully-burdened product cost is important for any business seeking to maximize profits. Implementations described herein avoid metric errors and thereby avoids expensive mistakes

The fully-burdened product cost consists of aggregated costs (e.g., costs associated with raw materials and components) and the allocation of overhead costs (e.g., equipment depreciation costs and facilities costs). Such allocated costs are typically straightforward and consist of applying overhead ratios to finished goods. Such ratios are usually dependent upon various allocation factors such as production volumes, facilities area usage, and machine time usage.

With regard to allocated costs portion of fully-burdened product costs, enterprises typically manage such allocation using spreadsheets having user-defined formulae or by using financial planning applications based on OLAP technologies or other business intelligence tools.

In various implementations, OLAP tools enable users to analyze multidimensional data interactively from multiple perspectives. OLAP consists of three basic analytical operations: consolidation (roll-up), drill-down, and slicing and dicing. Consolidation involves the aggregation of data that can be accumulated and computed in one or more dimensions. For example, all sales offices are rolled up to the sales department or sales division to anticipate sales trends. By contrast, the drill-down is a technique that allows users to navigate through the details. For instance, users can view the sales by individual products that make up a region's sales. Slicing and dicing is a feature whereby users can take out (slicing) a specific set of data of the OLAP cube and view (dicing) the slices from different viewpoints. The financial models employed by these tools usually make use of hierarchical data sets that may organize products in hierarchies that can run from finished goods at the leaf level, with roll up to product types, to product families, and finally to all products.

Other hierarchies may organize metrics such as revenues or production volumes by time periods (e.g., from months to quarters to years, etc.), component suppliers, manufacturing sites, and customer geographic regions. Among other things, arranging data in this way makes it convenient to interrogate the model for details at different levels of a hierarchy.

Raw material and component cost aggregation may be complex. As such, the relationship between a finished good and its constituent parts may be represented by a represented by a BOM. BOMs, in turn, can be modeled as directed acyclic graphs (DAGs), where graph nodes are components and graph edges represent relationships between the components, assemblies thereof, and finished goods. A DAG is a directed graph with no directed cycles. That is, a DAG is a collection of nodes and directed edges such that there's no way to start at some node and follow a sequence of edges that get you back to the same node. Example implementations of DAGs are described in more detail below.

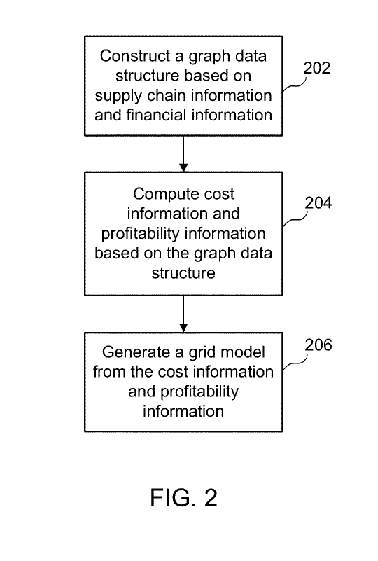

FIG. 2 illustrates an example simplified flow diagram for facilitating cost and profitability planning, according to some implementations. Referring to both FIGS. 1 and 2, a method is initiated in block 202, where system 10 constructs a graph data structure based on supply chain information and financial information. In various implementations described herein, the graph data structure may also be referred to as a “graph model.”

In various implementations, system 10 constructs the graph data structure by determining nodes and edges associated with the supply chain information and the financial information. For example, system 10 associates each node of the graph data structure with one or more of supply chain information and financial information, including component cost information and profitability information. The edges indicate a hierarchical relationships between the nodes in the graph data structure. In various implementations, the graph data structure is a DAG.

In some implementations, the supply chain information may include a map that represents a supply chain. In some implementations, the supply chain information may include BOM information. As such, system 10 may construct the graph data structure by determining nodes and edges of a map that represents a supply chain and/or determining nodes and edges of a BOM. As indicated herein, a BOM provides components for making something but does not provide information on how to assemble the components. For example, a BOM may indicate that the components for a bike include a frame, two wheels, wherein each wheel has one rim and 20 spokes, but the BOM would not indicate to assemble the spokes and rim into a wheel and attach it to the frame.

In various implementations, supply chain information contains BOM information and information on how to make the things that they describe. This is relevant to implementations described herein in that the system processes different costs, including costs associated with inputs that are required to make something and costs associated with transformation methods (e.g., spokes are $1 each, rim is $5 and it costs a $3 of a worker's time to assemble a wheel, where the $3 would not typically be found in a BOM).

As indicated above, the nodes may represent components, raw materials, and assemblies of a product (e.g., bicycle, computer, etc.), and the edges may represent relationships of the components and raw materials to form assemblies and final product. In various implementations described herein, the edges may be referred to as directed edges. Various example implementations of the graph data structure is described in more detail below.

While various example implementations are described in the context of supply chain information and financial information, system 10 may also determine the graph data structure based on other types of information, depending on the particular implementations. For example, in various implementations, system 10 may also determine the graph data structure based on volume information in combination with supply chain information and/or financial information.

In block 204, system 10 computes cost information and profitability information based on the graph data structure. For example, in various implementations, system 10 may compute the cost information and profitability information by traversing the graph data structure, and, more specifically, by traversing nodes and edges of the graph data structure.

In various implementations, system 10 computes the cost information from a combination of the supply chain information (e.g., BOM information) and financial information. As described in more detail below, the cost information may be based on effective usage and component unit cost associated with the nodes. Cost information may include, for example, procurement costs, transformational costs (e.g., wheat to flour, etc.), transportation costs, inventory carrying costs (e.g., warehouse cost), credits issued (e.g., rebates, discounts, etc.).

In various implementations, system 10 also computes profitability information from a combination of the supply chain information and financial information. As described in more detail below in various implementations, the supply chain information and financial information are stored in the nodes of the graph data structure.

In block 206, system 10 generates a grid model from the cost information and profitability information. In some implementations, the grid model presents data in grids or tables, and is organized using attributes and hierarchies imposed on those attributes. An example of a grid model is a spreadsheet. In various implementations described herein, the generation of the grid model may also be referred to as a graph data structure-to-grid model process, or a graph model-to-grid model process.

In various implementations, the grid model includes measures that are associated with dimension members arranged in hierarchies. For example, consider a time dimension that has months, quarters, and years. The particular months, quarters, and years (e.g., January, February, March, quarter 1, quarter 2, 2014, 2015, etc.) are all members of the time dimension. These members may be arranged in a hierarchy. For example, January, February, March may roll up to quarter 1; April, May, June may roll up to quarter 2, etc. Also, quarter 1, quarter 2, quarter 3, and quarter 4 may roll up to 2014, etc. Example implementations for generating the grid model are described in more detail below.

As described in more detail below, using the grid model, system 10 may capture key figures (e.g., units sold, sales price, etc.) in measures. System 10 may also analyze and report on measures in the context of dimension members arranged in hierarchies. For example, system 10 may determine and provide to a user unit sales in January, unit sales in quarter 1, etc. In another example, system 10 may also determine and indicate to a user if the sales price in January is greater than the sales price in February, etc.

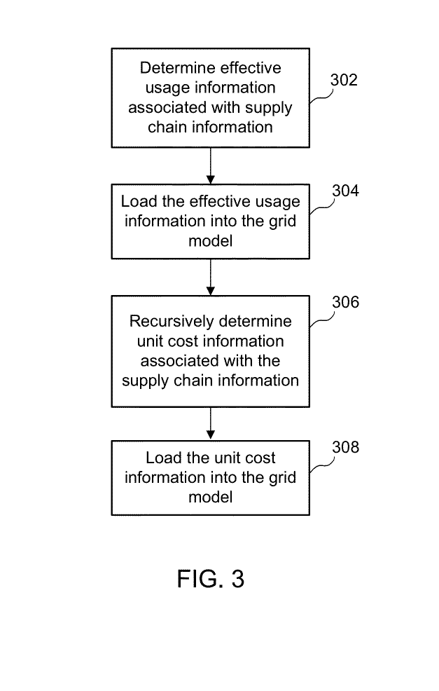

FIG. 3 illustrates an example simplified flow diagram for generating a grid model from a graph data structure, according to some implementations. Referring to both FIGS. 1 and 3, a method is initiated in block 302, where system 10 determines effective usage information associated with supply chain information. As indicated above, the supply chain information may include BOM information. As such, system 10 may determine or calculate effective usage information from nodes and directed edges of a BOM, where the nodes may represent components, raw materials, and assemblies of a product (e.g., bicycle, computer, etc.), and the directed edges may represent relationships of the components and raw materials to form assemblies and final product.

In some implementations, system 10 calculates effective usage information associated with the BOM. In various implementations, the effective usage information is based on the nodes and directed edges of the BOM. For example, in some implementations, system 10 calculates an effective usage for each node, where the effective usage information includes the effective usage for each node. In various implementations, the effective usage is the BOM usage factor for a given node (e.g., of a component, a raw material, or an assembly associated with a finished good), regardless of the node's position in the BOM. In some implementations, the effective usage for a given node may be computed by multiplying each edge's usage factor in the path starting from the component node up to the finished good node. Similarly, the effective usage for the root node at the root level is derived by multiplying all of the usage factors in all BOM branches starting from the leaf level(s) and running up to that root node.

In block 304, system 10 loads the effective usage information of each node into the grid model. In block 306, system 10 recursively determines unit cost information of each node associated with the supply chain information. In some implementations, system 10 exports the effective usage information to a table. As indicated above, the effective usage information includes the effective usage for each node. In various implementations, the table may be indexed by the component (and/or by raw material, assembly, etc), and by finished good. The table may be referred to as an effective usage table.

In block 308, system 10 loads the unit cost information (e.g., from the BOM) into the grid model. In some implementations, where system 10 exports the effective usage information to a table, system 10 loads the table into the grid model. In various implementations, the grid model may be a spreadsheet or financial planning application.

In some implementations, system 10 determines unit cost information from the supply chain information (e.g., a BOM) and loads the component unit cost into the grid model. In some implementations, if a given component is purchased, the purchase cost for that component is the unit cost, also referred to as the component unit cost. In some implementations, if a given component is made, the unit cost for that component may be calculated.

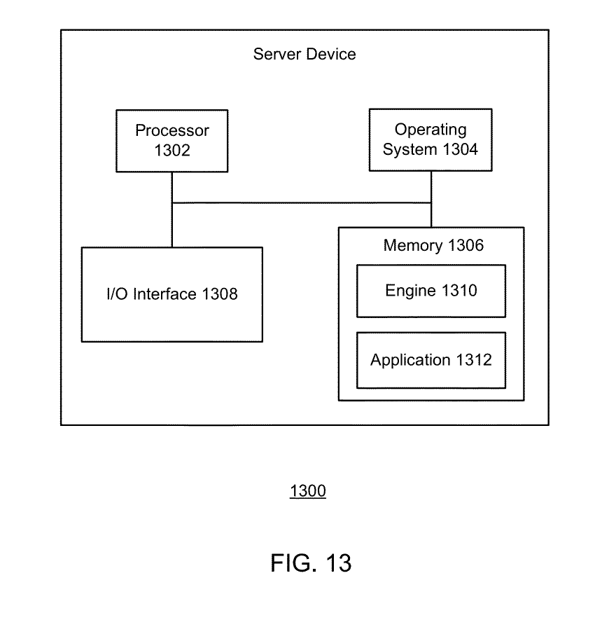

In various implementations, system 10 calculates the component cost used by the finished good. Component cost is defined as the sum over all components used in the finished good. The component cost may be the number (or amount) of the component used in the finished good times that component's unit cost. For example, the unit cost is the cost of a single item (e.g., a 4 GB memory chip). But the finished good might use 2 of such items. As such, the total component cost would be 2× unit cost. Example implementations are described in more detail below in connection with FIG. 13.

As indicated above, while processor 16 of system 10 may be used to perform the method steps as described in the example implementations described herein, any suitable component or combination of components of system 10 or any suitable processor or processors associated with system 10 or any suitable system may perform the steps described.

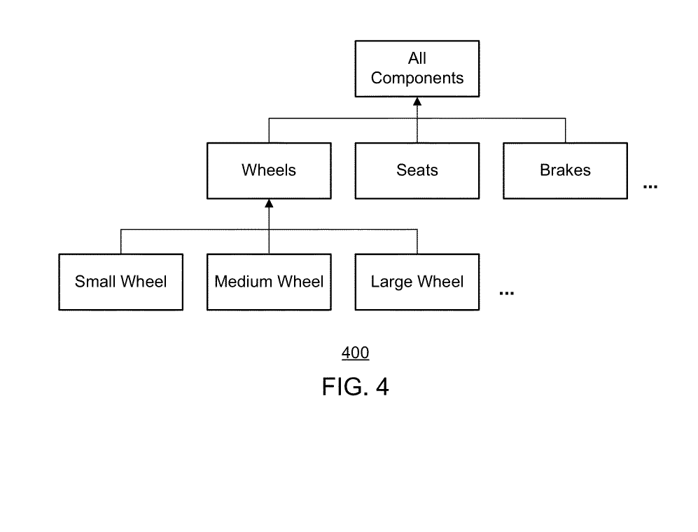

FIG. 4 illustrates an example graph representing a dimension hierarchy 400, where dimension hierarcy 400 shows component hierarchy members, according to some implementations. In some implementations, part classification may consist of grouping nodes in the GDBMS according to their types, where the types can be Wheel, Seat, Brakes, etc.

The queries for selecting input values from the GDBMS for analysis would be inferred from the grid. For example, to build the reports requested by the procurement analyst the system would generate GDBMS queries for:

[Total Demand, Extended Cost]×[Jan, Feb, Mar]×[Small Wheel, Medium Wheel, Large Wheel].

Once those values are returned, system 10 calculates aggregates along the Component and Time dimensions for determining Total Demand and Extended Cost.

In some implementations, graph nodes may have multiple properties that can be used as building blocks of hierarchies. Additional examples include supplier (for example, wheels might be sourced from different suppliers under different cost contracts), manufacturing site (for example, the bike factory might have manufacturing sites in the US and Mexico with different operating expense characteristics), color, size, etc.

Note that data can flow grid to graph as well as graph to grid. An example of the former case is an allocation of overhead costs down to products. For example, factory rent expense can be allocated down to nodes in the graph as a function of the volume of the products produced.

It is possible to construct analytic views on top of the data in the GDBMS by projecting onto it one or more hierarchy. For example, system 10 may interrogate the BOM graph for nodes with type=“Bike” that are members of the “Bike” category, which itself is a member of the “All Products” category. The aggregated values that result by summarizing values along hierarchies can be dynamic—calculated from scratch each time they are requested by the user, cached, or persisted to disk.

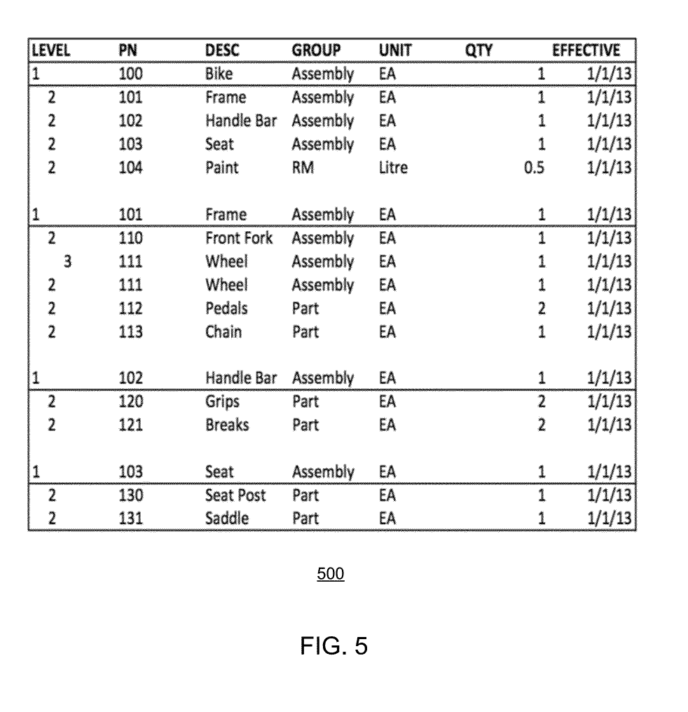

FIG. 5 illustrates an example table 500 rendered by a BOM, according to some implementations. As shown, the BOM includes the raw materials, assemblies, parts and quantities of each required to make a bicycle. In this example, the BOM is rendered as a table, which is one way to represent such information. When only a few items are involved, table views are generally easy to comprehend and allow for ready management of the records contained therein. Tables quickly become unmanageable, however, when tables grow to include numerous records (e.g., hundreds, thousands, tens of thousands, etc.).

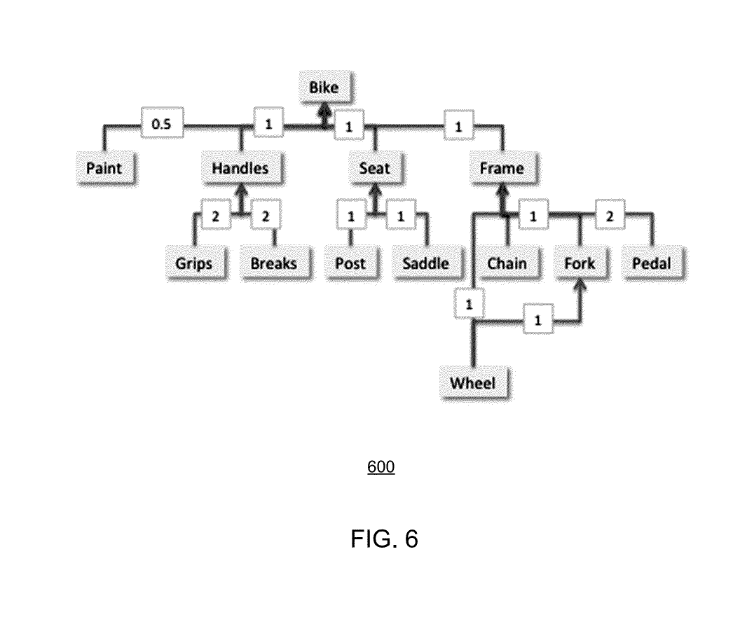

FIG. 6 illustrates an example graph rendered by a BOM 600, according to some implementations. In some implementations, BOM 600 is instantiated as a DAG. In this particular example, the DAG is for the bike BOM. As shown, the DAG is a collection of nodes (representing the components, raw materials and assemblies of a bicycle) and directed edges (representing the relationships of the components and raw materials to form assemblies and the final product). Direction indicates a traversal path through the DAG, which is relevant for modeling costs. As shown, the DAG provides a highly intuitive representation of the bike and its component parts and assemblies and arranges these elements in a manner well suited for efficient traversal.

In an example implementation, a BOM for a bike may include a node for a front fork assembly, which has constituent parts including a front axle and front wheel as children and a frame as a parent. If the same fork assembly is used by more than one bike model, then the node representing the fork assembly would have edges leading to multiple parents.

In various implementations, nodes in the graph contain a node ID, a set of parent edges, a set of child edges, and several intermediate cost metrics. The node ID points to metadata about the node, where the metadata includes node properties such as part number, description, supplier, unit cost, etc. Intermediate cost metrics may include the aggregated costs from the node's children. For example, if the unassembled front fork in the above example has a cost of $15, a wheel has a cost $10, and an axle has a cost of $2.50, and if the fork used one wheel and one axle, then its intermediate cost value would be $27.50.

Edges of a DAG representing a BOM can contain usage and yield information defining relationships between two components/assemblies represented as nodes. For example, one model of a laptop computer might use one (1) of a 4 GB memory chip but a different model laptop computer might use two (2) of the same memory chip. In the DAGs representing the BOMs for each laptop model (and here the two BOMs may be overlapping in the same DAG), the different quantities of the same constituent component (the memory chip) may be represented in the edges connecting the memory ship to a higher level assembly (e.g., a motherboard). Yield factors that account for component and/or assembly failures that occur during manufacture of the laptop computers may likewise be included in the edge information (e.g., as quantities over and above those strictly needed by the model of laptop being constructed).

Both edge and node properties can change over time. For example, the 4 GB memory chip may be sourced from two different suppliers (A and B) and the laptop computer manufacturer might switch between the suppliersat various times to take advantage of more favorable pricing. From a cost modeling standpoint, this means that the part from supplier A at supplier A's price should be used until the switch date but after the switch date the part from supplier B at supplier B's price should be used.

Costs are aggregated recursively using an aggregation function. The aggregation function is a recursive function that starts at the leaf level of a BOM—parts that have no subparts—and traverses along the edges up to the root level—a part with no parents—adding up costs along the way. In the simplest form, one application of the aggregation function is a sum of (intermediate cost*usage) for all children. In the general case, there can be many different aggregation functions, where each aggregates differently across disparate node properties.

Although the fully-burdened product cost, and therefore the costs associated with a BOM for a given product, are critical to understanding profitability, conventional business intelligence tools provide little, if any, linkage between so-called “costed BOMs” (commonly employed at the operations level of an enterprise) and the hierarchical data sets used by OLAP-based and other financial planning and analysis engines (commonly used by financial officers of the enterprise). Stated differently, within enterprises there exists a deficiency in terms of the automated systems available to members of the enterprise, inasmuch as the tools currently employed by those individuals do not include adequate facilities for determining and utilizing fully-burdened costs associated with goods or services produced by the enterprise. As a result, financial professionals are forced to rely on proxies for these fully-burdened costs when conducting financial planning. Because such proxies often represent approximations of the true fully-burdened costs of the subject good or services, especially where user customizations of products can lead to BOMs representing hundreds or even thousands of different product configurations, financial plans that rely on them are never fully accurate.

Implementations described herein address deficiencies of conventional business intelligence tools and have developed solutions in the form of methods and systems for integrating data management and analysis that connect OLAP-style financial models to complex operations details in structures such as BOMs.

Implementations described herein provide a computer-based application for planning and analyzing an enterprise's operations finances that enables users to derive fully-burdened product costs by integrating an OLAP-style allocation engine with a graph database management system for aggregations.

Implementations also enable users to derive total unit costs, or fully burdened unit costs, for finished goods by traversing respective BOMs and aggregating costs for components. As described in more detail below, system 10 traverses bottom up (e.g., starting with components, going up to assemblies, and finally to finished products).

Implementations also enable users to derive extended costs for components by traversing BOMs and scaling unit costs by total demand. As described in more detail below, system 10 traverses top down for each finished good, records its demand. System 10 then recursively cascades down the BOM paths, scaling this demand by the usage information in the edges, thereby visiting all nodes in the graph.

Implementations also enable users to analyze (e.g., slice and dice) cost metrics derived from graph traversal independently along finished good and component hierarchies. For example, system 10 enables analysis of total costs for all products, a family of products (e.g., laptops) or a particular product; total costs for a particular component or group of components; costs by component, group of components, product, or group of products, etc.). In some implementations, there may be other hierarchies as well, in addition to product and component hierarchies. For example, system 10 may do analysis by manufacturing site or supplier.

Implementations also enable users to compare different financial plans to one another and understand root causes of variances.

Implementations also enable users to create alternate plans on-the-fly to test the impact of new financial assumptions, such as unit cost and overhead values, and operational assumptions, such as usage and yield.

Implementations also enable users to collaborate on analysis and exception resolution with teammates via plan sharing.

Implementations also enable users to review audit trails of node and edge changes for compliance and to understand which assumptions were modified, by whom, when and why.

In some embodiments, the GDBMS may be a specialized in-memory database populated from a separate BOM management system (e.g., a product lifecycle management or PLM systems) or from one or more relational database tables and optimized for traversal of time-varying DAGs. It supports a node classification scheme, which allows for the specification of node-dependent calculation functions. For example, system 10 may use one or more use functions for aggregating costs for nodes of particular types. It also supports bidirectional graph traversal, for example, BOM roll-ups for cost aggregation and roll-downs for extended cost calculation.

Referring still to FIG. 6, in various implementations, system 10 may tag nodes of the DAG according to type(s) or other desired property. For example, as shown, system 10 may tag nodes with associated colors corresponding to types (e.g., finished good, assembly, raw material, part, etc.). Tags are a convenient way to facilitate selection from the graph. For example, using tags allows for the use of query-based selection according to tag property. Tags also facilitate various forms of analysis.

Tags also facilitate security of information. For example, an individual tasked with planning raw material acquisition may require access to permit forecasts of raw material usage, but need not have access to information associated with other nodes. The use of tags in DAGs representing BOMs allows for segregation of information according to tag type while still permitting a view of an overall BOM, where appropriate.

Tags also facilitate the development of hierarchies on top of finished goods. Hierarchies are a basic building block of financial analysis models. A typical analysis task for a financial planner is to understand profitability by product across geographic regions. To do this, the financial planner can construct a pivot table view that shows profitability metrics summarized at different levels of product and geography hierarchies.

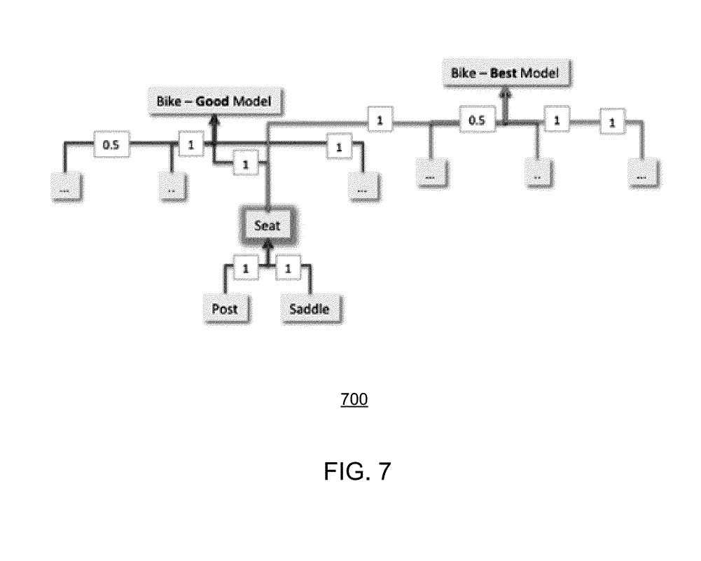

FIG. 7 illustrates example graphs rendered by a BOM 700, according to some implementations. As shown, DAGs are also useful for representing shared nodes among different finished goods. In some implementations, one DAG represents a BOM for one model of bicycle (“Bike—Good Model”), while the other DAG represents a BOM for a different model of bicycle (“Bike—Best Model”) that uses the same seat component as the bicycle represented by the DAG.

In various implementations, the DAGs for BOM 700 may be instantiated from a plurality of tables (e.g., stored in a relational database or other database) that store node attributes and edge relationships. For example, the BOM 700 may be instantiated from table 500. Other examples of tables that represent BOM items are described in more detail below.

The following describes implementations involving the construction of hierarchies. In some implementations, system 10 may construct product hierarchies from a graph, where system 10 selects a subset of a graph. In some implementations, system 10 uses tags to select the subset of the graph.

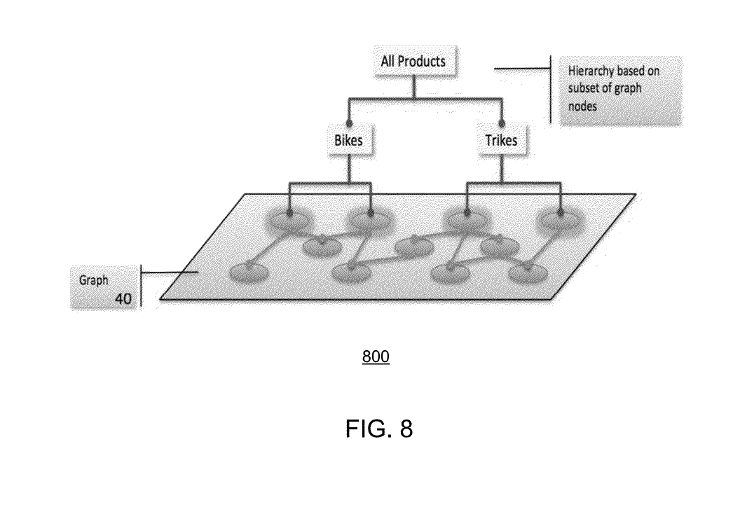

FIG. 8 illustrates an example graph 40 representing a BOM with a dimension hierarchy projected onto it, according to some implementations. As shown, graph 40 represents BOMs for bicycles and tricycles. Notice that the two types of finished goods share some components.

In this example, system 10 selects two finished goods nodes (e.g., bikes and trikes). In some implementations, multiple different hierarchies can be created in this way from the same graph data set. Also, a given node may participate in more than one hierarchy. For example, a node tagged with a raw material tag and a supplier tag can belong to both raw material hierarchies and supplier hierarchies. In various implementations, when analyzing hierarchies, system 10 may include functions of a conventional OLAP-based financial planning tool.

The following describes implementations involving graph revisions. Implementations described herein also support variations in graphs over time (e.g., due to changes in BOMs over time). For example, in various implementations, system 10 determines changes to the graph data structure. Changes to the graph data structure may result from changes in BOMs. Generally, BOMs are dynamic in nature and change over time as suppliers introduce new components, fabrication processes and raw materials, and manufacturers change and/or add suppliers, components and raw materials, negotiate new pricing, and also innovate and create new sub assemblies, assemblies and finished goods.

In various implementations, in response to determining changes in the graph data structure, system 10 generates a heat map based on the changes.

In some implementations, changes in a DAG representing a BOM require that financial plans also change, but only prospectively. To understand this, consider that a financial plan is constructed on the basis of one or more BOMs as of a designated point in time. This requires that in order to perform a comparison of two plans, A and B, created at different points in time, system 10 makes available the underlying BOMs that were in effect when plan A was created and those that were in effect when plan B was created.

To accommodate this, implementations may incorporate graph revisions. In some implementations, system 10 may generate a timestamp for an entire instance of a graph. As each change is introduced in the BOM, system 102 generates a new graph revision (e.g., a new timestamp) for each corresponding graph. When a financial plan is created, that plan receives a specified creation date, which is used to select a graph revision. This makes it possible to select the correct version of the BOMs for each plan.

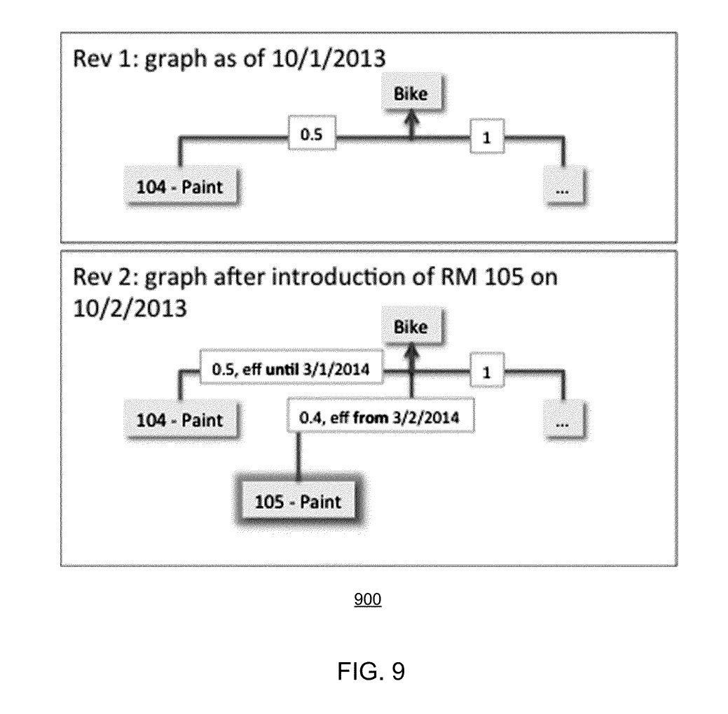

FIG. 9 illustrates example graph revisions 900, according to some implementations. As shown, an existing BOM for a bicycle on Oct. 1, 2013 (designated Rev 1) specifies the use of 0.5 units of paint 104. A change in the BOM (to Rev 2) is then introduced to reflect the fact that on Mar. 2, 2014, 0.4 units of a new paint 105 will be used. Assume for purposes of the example that the change in the BOM was made on Oct. 2, 2013. System 10 is configured so that plans created prior to Oct. 2, 2013, the date the BOM change was introduced, are based on the BOM represented by Rev 1. That is, plans that were created prior to Oct. 2, 2013 but that make projections even beyond Mar. 2, 2014 are always based on Rev 1 of the BOM, even though it is now known that in March 2014 a change will be made. This is because the change in the BOM was not known until Oct. 2, 2013, and so plans created prior to that date cannot reflect such revisions. Of course, the system 10 is also configured so that all plans created on or after Oct. 2, 2014 are based on Rev 2 of the BOM and take into account the use of fewer units of new paint 105 after Mar. 2, 2014.

The following describes implementations involving metadata driven BOM calculation functions. In some scenarios, some models require different node value calculation functions to be applied at different levels in the BOM. An example of this is the semiconductor industry. There, the manufacturing process consists of steps that include converting raw silicon into wafers, sorting the wafers, processing the wafers to produce what will become integrated circuits, cutting the wafer into pieces (dies), packaging and assembly of the dies into chips, and finally testing of the chips (or some representative sampling thereof). While the cost calculation in the processing step is a function of the number of metal and mask layers, the cost of the sorting step is a function of parameters like sort time and sorting machine hourly rate.

To facilitate the different kinds of computations required by the system 10 (e.g., modeling flexibility that accounts for arbitrary cases), the notion of graph node types is introduced. In the example above, node types may include RAW_MATERIAL, WAFER, SORT, PROCESSING, DICE, PACKAGE, and TEST. The system implements custom BOM cost aggregation functions for each node type. The function signature specifies which parameters are necessary for the calculation and system 10 extracts them by interrogating the relevant node. For example, the WAFER node type cost function may consider parameters metal_layers and mask_layers.

The following describes implementations involving a contextual assumption query generation. In the basic analysis flow, planners consider just total costs at various levels in the BOMs and along the product hierarchy. The cost calculation functions derive total cost by operating on several parameters, which serve as the inputs or assumptions for the total cost calculation. In order to explain results, planners review and understand those assumptions.

The function parameters captured by system 10 as node and edge attributes are those assumptions. Given any node or edge across all BOMs, the system is able to render the assumptions behind that node's cost value by interrogating the node or edge.

For example, a user examining the cost of a node of type WAFER might see that its cost is $3.52. The user can then delve into that value to discover the underlying assumptions, which would show that the particular wafer uses 7 metal layers at $0.28 each and 13 mask layers at $0.12 each.

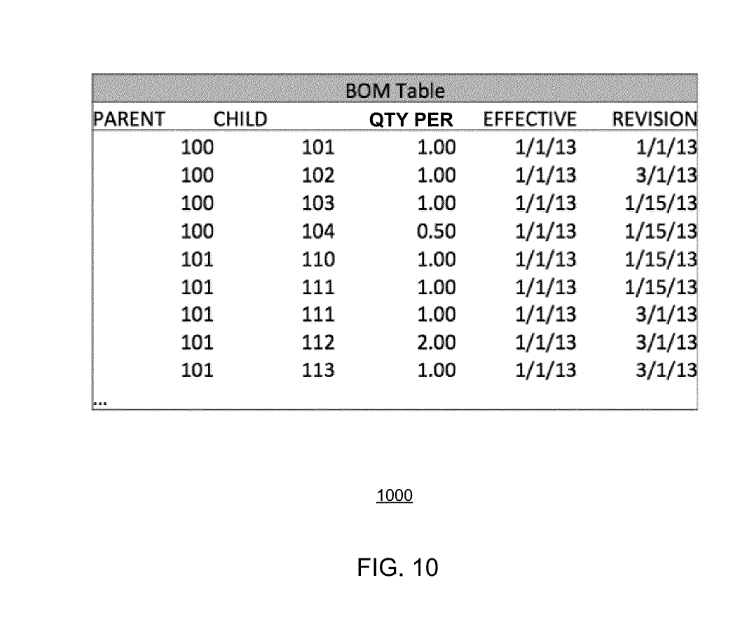

FIG. 10 illustrates an example BOM table 1000, according to some implementations.

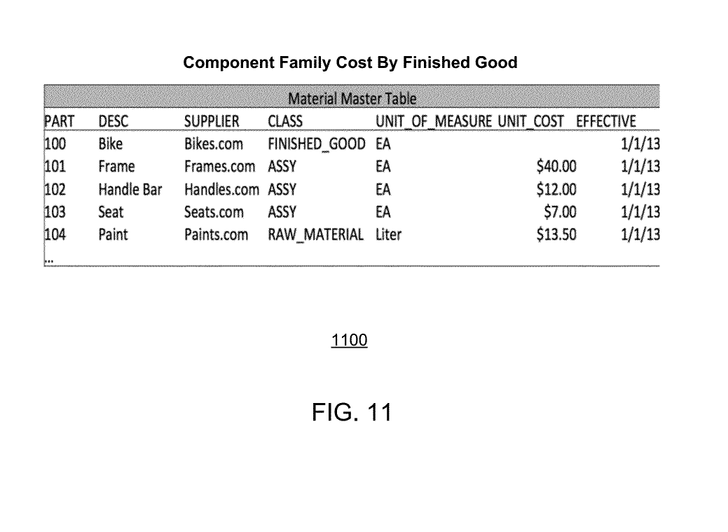

FIG. 11 illustrates an example material master table 1100 (labeled “Component Family Cost by Finished Good”), according to some implementations. Notice that the tables include an “effective” date. The use of such dates in constructing BOMS and plans based on BOMs are described below. DAGs representing BOMs are constructed by a processor (e.g., processor 16 of FIG. 1) reading the tables, instantiating raw materials, parts, etc. as leaf nodes, and constructing edges to assemblies and finished products in accordance with the relationships specified in the table. In various implementations, parent-child relationships may be specified, allowing directed edges to be constructed by processor 16 in accordance therewith.

As indicated above, DAGs provide for straightforward traversals. Efficient traversal is important for building product cost models and for determining demand for component parts. For example, in some implementations, to determine the demand for wheels per bicycle, system 10 need only execute instructions to traverse down the BOM starting from the finished good to determine that two (2) wheels are needed per bike. In some implementations, to determine the cost of a bicycle, system 10 need only execute instructions to traverse up the graph in the direction of the edges and aggregate the cost at each node as weighted by the information from the edges. The following described implementations involving graph flattening.

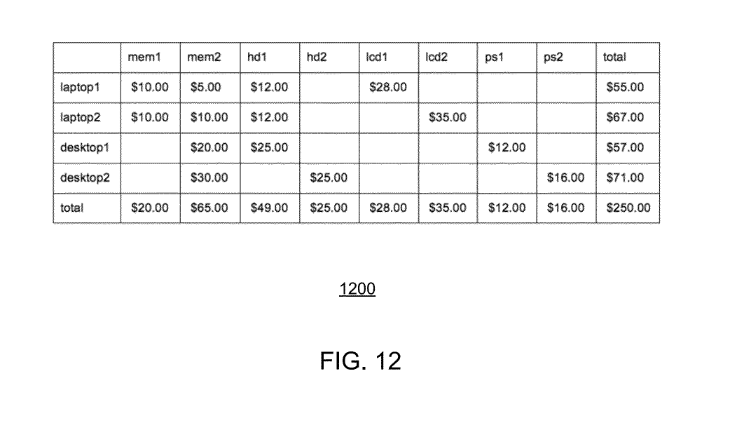

FIG. 12 illustrates an example grid structure 1200, according to some implementations. In various implementations, financial models may assume a grid structure, as in a spreadsheet. For example, an analysis might call for reviewing component cost by finished good. However, as discussed above, actual component costs may be derived by traversing the graph data structure (e.g., graphs representing BOMs), where graphs may specify component-to-finished-good relationships. As such, implementations provide for extracting component cost information from graph models of BOMs to produce grid-like tables in order to facilitate integration with conventional financial tools, such as business intelligence tool 30.

Consider, for example, a situation where various models of computer systems (e.g., laptop1, laptop2, desktop1, desktop2, etc.) each use various memories (e.g., mem1, mem2, etc.), hard disks (e.g., hd1, hd2, etc.), display screens (e.g., lcd1, lcd2, etc.), and/or peripheral (e.g., ps1, ps2, etc.). One example of an approach for converting the BOM information stored in a DAG to a grid suitable for use in a financial analysis tool is as follows.

In some implementations, system 10 uses the grid model to calculate the component cost used by each finished good using the formula=Effective Usage*Component Unit Cost. For example, if laptop1 uses two (2) of component mem1 priced at $5 each, then Effective Usage is 2 and the total cost of mem1 in laptop1 is 2*$5=$10. A less trivial case is when 2 of component mem1 go into a subassembly, 2 of which are used by laptop1. Here, Effective Usage would be 2*2=4. Effective Usage can be affected by other metrics, such as Yield. For example, if there is 10% yield loss in putting mem1s into the subassembly, then Effective Usage becomes (2/0.9)*2=4.44.

As described above, the information captured by traversing the graph (e.g., DAG) is transformed, or flattened, into an intermediate form—a table indexed by the columns in the grid—and finally pivoted into the grid. Note also that the total cost of a graph node may be derived from four cost components: allocated, rolled-up, and local. Allocated costs are a fraction or ratio of some overall cost applied to the node on a determined basis. Overhead (fixed) costs for plant management are an example and may be allocated on a per unit basis. Rolled-up costs are aggregated as one traverses along the directed graph from leaf nodes. Local costs are additional costs due to the node itself. For example, a bicycle frame might have a local assembly cost incurred as a result of having to attach the fork and seat assemblies. The total cost of a node is then the sum of allocated, rolled-up, and local costs. Note that all these costs vary over time, hence, BOM graph calculations are always in the context of some graph revision, as explained further below.

In some implementations, it may be useful to analyze effective usage for subassemblies below the finished good level. To accommodate such cases, implementations provide for any node (not necessarily a root-level finished good) to be “flattened” per the methodology described herein.

In some implementations, effective usage may not be needed for all components. For example, it may not be relevant to model costs for inexpensive parts, which can be treated as a single add-on cost. However, in various implementations, all parts are to be included in BOM traversal, because a part which requires an effective usage calculation can be a child of a part that does not. To accommodate such cases, system 10 allows for arbitrary nodes to be tagged to indicate that they should also be “flattened.”

In some implementations, an effective usage calculation takes into account the time information stored in graph edges. For example, laptop1 might use mem1 (e.g., until Mar. 8, 2014) and mem1a (e.g., after Mar. 8, 2014). In various implementations, the effective usage calculation accounts for this and records values for mem1 (e.g., until Mar. 8, 2014) and for mem1a (e.g., after Mar. 8, 2014).

Some implementations may employ a simplified user interface for viewing a BOM mode. The interface may provide a dashboard-like view of the BOM model in a panel. For any node of the BOM that is selected, node properties are presented in the panel. Users are permitted to navigate to views that show where the part represented by the node is used (e.g., in various sub-assemblies, assemblies and/or finished products), and, if the node is an assembly, its constituent parts. Users may also be permitted to view variances between plans involving the subject node. A simplified interface and the other interfaces described herein are examples of graphical user interfaces generated by system 10 based on computations such as those described herein and rendered with a Web browser on client 12. As such, the interfaces may be HTML pages or other browser-renderable information transmitted from system 10 to client 12 over one or more networks. The pages may be generated in response to various user input, such as selection from menus or other options. The interfaces may also include Javascript or other elements to display dynamic information or facilitate user input. In other embodiments, the interfaces may be rendered as part of a proprietary application running on client 12.

The following describes implementations involving automatic alternate plan creation. The plans variance analysis features of system 10 allow planners to compare two plans at different levels of detail in order to understand the reasons behind the differences. Plans can be of type base or alternate. A base plan is based on data imported from external systems. An Annual Operating Plan (AOP) plan and a plan based on a most recent set of actual financial data are two examples. An alternate plan is a plan created by a user either by layering in a set of changes on top of an existing base plan or by creating it with entirely new assumptions.

A simplified user interface may be used, for example, for presenting results based on different plans, according to some implementations. In an example, two plans H and L are being compared. These plans may represent costs associated with BOMs that represent different sets of assumptions. The constituents of the plans are presented and may be selectable from a panel. For example, a user may navigate to the underlying BOMs to understand what is being analyzed. Drop down menus or other user interface elements may be used to select plans for comparison. Importantly, variances between the plans are provided.

When comparing two plans, for example, an AOP plan and an Actuals plan, a user may wish to test the impact of a new set of assumptions for the AOP when deep into the variance analysis. Instead of having to start a new workflow to create an alternate plan off of the AOP, find the user's way back to the point in the analysis that the user wanted to test, and introduce the desired changes, through the use of the present interfaces the user can simply update the assumptions UI in-place. System 10 automatically creates a new alternate plan from AOP, introduces the specified changes and recalculates all dependent values, generates a new comparison to include the alternate plan and the Actuals plan, and restores point-of-view to the same location.

In some implementations, demand for a specified component is updated and those updates may then be used to determine a new plan cost. The updated comparison can be accessed by selecting the link in a panel. Logs of all such “what-if” scenarios may be kept for audit and other purposes.

In some scenarios, a given graph can have many nodes and edges. The changes introduced as part of an interactive analysis, however, will be relatively small in volume as compared to the total. In some implementations, system 10 recalculates the graph efficiently by not revisiting all nodes and edges, thereby saving time. In some implementations, system 10 determines changes to the graph data structure, wherein the graph data structure contains the nodes and the directed edges. The graph model may include one or more graphs. System 10 captures such changes to the graph models in a change log. System 10 also determines or identifies dependent subgraphs of the graph data structure. In various implementations, a dependent subgraph is the set of nodes whose values may be affected by the introduced changes in the graph model. System 10 updates or adjusts one or more of the dependent subgraphs based on the changes (e.g., to reflect the changes). In some implementations, system 102 may apply a traversal algorithm to adjust dependent subgraphs.

The following describes implementations automatic variance contribution analysis generation. The difference between the total values of two plans can be due to differences in volume, costs, or mix. Volume and cost are self-evident. If the difference is that plan A called for 100 units and plan B for 150, then the difference between the two plans is entirely due to the 50 unit variance. Similarly, if the difference is that some part in plan A costs $1 and in plan B the same part costs $0.50, then the difference is due to cost. A mix variance happens when plan A expected to sell an even split of products but plan B called from a 60/40 split. The reality is almost always more complex, where variances are due to a combination of factors.

In some implementations, a simplified user interface may be utilized for variance contribution analysis, according to some implementations. In various implementations, system 10 may use variance contribution analysis for comparing two hierarchical data sets and breaking apart a cost variance into its cost-volume-mix components. In some implementations, system 10 generates contribution analysis at all levels of all hierarchies automatically. In some implementations, to generate contribution analysis, system 10 infers through metadata which metrics represent volume and cost and automatically calculate mix splits. For example, variances may be broken down by price, volume and mix on a per-component basis. All of the data contributing to this analysis is stored in the DAG representing the product BOM, either as node attributes or edge attributes. Variance analyses for different products and/or different time periods can be selected.

The following describes implementations involving graph variance analysis using heat maps. In some various implementations, a graph representing all BOMs for a typical product manufacturer can contain hundreds, thousands or millions of nodes, and even tens of millions of edges. While variance analysis of well-structured hierarchical data sets is well understood, implementations described herein are able to identify the drivers of variances in large time varying graphs. For example, implementations may identify the variances in yields that lead to significant cost impact.

System 10 addresses this problem by generating a “heat map” style view on top of differences between two graph revisions, that highlights locations which drive significant cost variances. To produce such a heat map, system 10 (e.g., processor 16 acting under appropriate program control), system 10 determines differences between two revisions of a graph model containing the nodes and the directed edges. In some implementations, system 10 computes deltas/differences and percentage deltas/differences for all node and edge metrics between graphs associated with different revisions (e.g., graph diff). System 10 then generates a heat map based on the differences.

In some implementations, system 10 assigns a color code to each variance. Each color code is a function of the relative size of the difference—the greater the percentage change, the more severe the color.

The system then renders the resulting graph. The system renders each node and edge color coded as required by the above. Thus, the colors indicate hot spots indicating problem areas in the BOM that the user can then easily identify. Once identified, the user can zoom in to the affected parts and perform more detailed analysis.

The following describes implementations that provide continuously up-to-date cost and margin plans based on BOMs. Traditionally, cost and margin plans are constructed in complex spreadsheets that contain information exported from other enterprise systems at a particular point in time and are used as inputs to an incomplete product cost/profitability model.

Some conventional models are incomplete. For example, many conventional spreadsheet models do not look at the BOM, and thus cannot manage a DAG structure. As such, many components and processes that account for a product's cost are missing. In contrast, implementations described herein sync directly to PLM systems. As such, the system may always determine BOM information at any given point in time, enabling complete, accurate, and predictable cost/profitability analysis.

Some conventional models are out-of-date. For example, many conventional spreadsheet models are out of date because they contain information exported from systems once. Such spreadsheets need to be manually refreshed. In contrast to conventional models, implementations described herein connect to systems of record (e.g., PLM systems) and thus has the latest information for cost models.

Some conventional models are slow. For example, many conventional spreadsheet models are complicated, and can take days to weeks to make. In contrast to conventional models, implementations described herein enable individuals (e.g., CFOs) to answer financial questions regarding costs immediately.

The following describes implementations that provide ad-hoc OLAP cubes. Traditional OLAP analytic stools must have dimensions (e.g., Products), hierarchies (e.g., All Products>Mobile Phones>iPhone5), and OLAP cubes constructed from multiple 2 or more dimensions which define the grid, or table, of numbers to analyze. An example OLAP cube might be [Supplier dim]×[Component dim]×[FY14-Q1] which would show a table of component costs by supplier for FY14-Q1. OLAP cubes are explicitly defined by programmers in IT departments in these tools as part of a customization process.

While some implementations described herein may utilize externally defined dimensions and hierarchies, these implementations and others do not require that OLAP cubes be defined. In various implementations, the system infers the OLAP cube structure based on what the user wants to see. The system then computes the cube on-demand as needed, without actually constructing a cube. In this way, the system does not require a typically complex, expensive, slow process to define OLAP cubes. Because implementations may skip any type of OLAP cube instantiation, implementations are lightweight on system resources such as memory and disk.

Implementations described herein automatically generate OLAP hierarchies from a BOM graph. Conventional OLAP analytics systems require that dimensions and hierarchies be defined externally and loaded into the analytics systems. This data is kept separate from DAGs that capture BOM structures. In contrast from conventional models, implementations described herein obviate the need for externally defined dimensions and hierarchies by interrogating BOM nodes. That is, in various implementations, the nodes themselves contain information that can be processed to generate OLAP dimensions and hierarchies, and categorize the node within those hierarchies.

This section describes the end-to-end calculation flow to get to a fully burdened cost and perform analysis on it. The following description introduces the notion of independent and dependent demand. A node's independent demand is a demand that originates externally and does not depend on any other item. A node's dependent demand occurs when there exists demand for that node's parent. For example, demand on finished goods is typically independent, while demand on subassemblies and components is typically dependent.

With regard to demand propagation, at the end of this process, every node in the graph representing all of the BOMs will contain its demand value. The system loads independent demand from external financial plan data to finished goods. The system cascades the demand of each finished good down its BOM to derive dependent demand for its children by scaling the parent's demand by the “effective usage” specified by the parent-child edge. The system then recursively cascades down until all paths in all BOMs have been visited and all dependent demands have been derived.

With regard to materials cost calculations, at the end of this process, every node will contain intermediate cost calculations, including local cost and rolled up cost from all of its children. In some implementations, for each node, starting at the leaf level of every BOM, system 10 recursively traverses up the graph via all of the edges specified by all of the BOMs, and calculates the following: local cost, rolled up cost, allocated cost, total cost, and extended cost, independent cost, dependent cost, and total demand.

As described above, the local cost is the cost for making or assembling that node. For example, if the node is a seat assembly with children parts seat and seat post, its cost might be the time required to attach the seat to the seat post.

The rolled up cost is the total cost for all of the node's children. The allocated cost is cost not derived from BOM relationships but rather associated with the node due to an external function. For example, the bike factory rent expense might be allocated to each bike model produced there as a function of the model volume. If a factory produced 100, 200, and 300 units of bike models A, B, and C, respectively and if it incurred a building rent expense of $2,000 in a given period, then model A would be allocated $333.33, model B $666.67, and model C $1,000.

The total cost is the sum of local cost, rolled up cost, and allocated cost. The total cost may also be referred to as unit cost. The extended cost is total cost*total demand (independent demand+dependent demand), In various implementations, each node in the graph has a unit cost, extended cost, and total demand.

In some implementations, every node in the graph has computed cost and demand attributes populated. A graph in this state is said to be consistent because values in each node are correct relative to all nodes that it depends on—that is, relative to all of its ancestor and descendent nodes. Note that the unit cost at the finished good level is the finished good's fully burdened cost. The results of this sequence of operations can be derived dynamically at query time, cached in memory, or persisted to disk.

The GDBMS can use different data structures with different storage media to represent the graph resulting from the BOMs. One implementation is to use an in-memory adjacency list, which represents a graph as a collection of lists, one for each node in the graph, where each list is the set of neighbors of its node.

Recall the bike factory that produced three bike models. Each bike model might specify different kinds of wheels in its BOM. Furthermore, each model might come in several sizes, so each kind of wheel may be available in different sizes. The different bike models can also utilize different kinds of seats, pedals, brakes, and so on.

Analytic models generally present data in grids, or tables, organized using attributes and hierarchies imposed on those attributes. One purpose of such grids is to present data at different levels of detail. For example, a procurement analyst responsible for wheels would be interested in subtotals of demand and cost for all wheel parts for the current financial reporting quarter across all products that use wheels.

The following is an example flow for generating a grid, according to some implementations. A method is initiated where system 10 defines a set of attributes for analysis. System 10 may then constructs hierarchies for each of the attributes. System 10 may then selects input values from the GDBMS. System 10 may then calculates aggregates. In the example above, the attributes are component type and time.

Implementations described herein provide various benefits. For example, implementations providing a product cost and profitability planning system that is suitable for use within a variety of enterprises and industries have been described. For example, implementations may apply to operations finance planning. Implementations may also apply to product development and engineering. Implementations may also apply to various corporate finance analyses. Moreover, implementations may also apply to product launches and cost monitoring.

FIG. 13 illustrates a block diagram of an example server device 1300, which may be used to implement the implementations described herein. For example, server device 1300 may be used to implement operations finance planning system 10 of FIG. 1, as well as to perform the method implementations described herein. In some implementations, server device 1300 includes a processor 1302, an operating system 1304, a memory 1306, an input/output (I/O) interface 1308. Server device 1300 also includes an engine 1310 and an application 1312, which may be stored in memory 1306 or on any other suitable storage location or computer-readable medium. Application 1312 provides instructions that enable processor 1302 to perform the functions described herein and other functions.

For ease of illustration, FIG. 13 shows one block for each of processor 1302, operating system 1304, memory 1306, I/O interface 1308, engine 1310, and application 1312. These blocks 1302, 1304, 1306, 1308, 1310, and 1312 may represent multiple processors, operating systems, memories, I/O interfaces, engines, and applications. In other implementations, server device 1300 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a networked system. However, the implementations described herein may apply in contexts other than a networked system. For example, implementations may apply locally for an individual user.

Features under a single heading need not be implemented in same implementation together. Also, features under different headings may be used together from implementations described under other headings.

The foregoing description includes references to the accompanying drawings, which form a part of the detailed description. The drawings show specific implementations by way of illustration. In the various descriptions, these embodiments are also referred to herein as “implementations” and/or “examples.” Such examples may include elements in addition to those shown or described. Such examples may optionally omit some elements mentioned. Moreover, such examples may include any combination or permutation of those elements shown or described (or one or more aspects thereof).

Note that the functional blocks, methods, devices, and systems described in the present disclosure may be integrated or divided into different combinations of systems, devices, and functional blocks as would be known to those skilled in the art.

Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments. For example, a tangible medium such as a hardware storage device can be used to store the control logic, which can include executable instructions.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a,” “an,” and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A computer-implemented method comprising:
determining a graph data structure based on supply chain information and financial information;
determining cost information and profitability information based on the graph data structure; and
generating a grid model from the cost information and the profitability information, wherein the grid model includes measures that are associated with dimension members arranged in hierarchies.

2. The method of claim 1, wherein the determining of the graph data structure comprises determining nodes and edges associated with the supply chain information and the financial information.

3. The method of claim 1, wherein the graph data structure is a directed acyclic graph.

4. The method of claim 1, wherein the determining of the cost information and profitability information comprises traversing the graph data structure.

5. The method of claim 1, wherein the generating of the grid model comprises:
determining effective usage information associated with the supply chain information;
loading the effective usage information into the grid model;
recursively determining unit cost information; and
loading the unit cost information into the grid model.

6. The method of claim 1, further comprising:
determining changes to the graph data structure; and
generating a heat map based on the changes.

7. The method of claim 1, further comprising:
determining changes to the graph data structure;
determining dependent subgraphs of the graph data structure; and
updating the dependent subgraphs based on the changes.

8. A computer-readable storage medium carrying one or more sequences of instructions thereon, the instructions when executed by a processor cause the processor to perform operations comprising:
determining a graph data structure based on supply chain information and financial information;
determining cost information and profitability information based on the graph data structure; and
generating a grid model from the cost information and the profitability information, wherein the grid model includes measures that are associated with dimension members arranged in hierarchies.

9. The computer-readable storage medium of claim 8, wherein to determine the graph data structure, the instructions further cause the processor to perform operations comprising determining nodes and edges associated with the supply chain information and the financial information.

10. The computer-readable storage medium of claim 8, wherein the graph data structure is a directed acyclic graph.

11. The computer-readable storage medium of claim 8, wherein to determine the cost information and profitability information, the instructions further cause the processor to perform operations comprising traversing the graph data structure.

12. The computer-readable storage medium of claim 8, wherein to generate the grid model, the instructions further cause the processor to perform operations comprising:
determining effective usage information associated with the supply chain information;
loading the effective usage information into the grid model;
recursively determining unit cost information; and
loading the unit cost information into the grid model.

13. The computer-readable storage medium of claim 8, wherein the instructions further cause the processor to perform operations comprising:
determining changes to the graph data structure; and
generating a heat map based on the changes.

14. The computer-readable storage medium of claim 8, wherein the instructions further cause the processor to perform operations comprising:
determining changes to the graph data structure;
determining dependent subgraphs of the graph data structure; and
updating the dependent subgraphs based on the changes.

15. A system comprising:
one or more processors; and
logic encoded in one or more tangible media for execution by the one or more processors and when executed operable to perform operations comprising:
determining a graph data structure based on supply chain information and financial information;
determining cost information and profitability information based on the graph data structure; and
generating a grid model from the cost information and the profitability information, wherein the grid model includes measures that are associated with dimension members arranged in hierarchies.

16. The system of claim 15, wherein to determine the graph data structure, the logic when executed is further operable to perform operations comprising determining nodes and edges associated with the supply chain information and the financial information.

17. The system of claim 15, wherein the graph data structure is a directed acyclic graph.

18. The system of claim 15, wherein to determine the cost information and profitability information, the logic when executed is further operable to perform operations comprising traversing the graph data structure.

19. The system of claim 15, wherein to generate the grid model, the logic when executed is further operable to perform operations comprising:
determining effective usage information associated with the supply chain information;
loading the effective usage information into the grid model;
recursively determining unit cost information; and
loading the unit cost information into the grid model.

20. The system of claim 15, wherein the logic when executed is further operable to perform operations comprising:
determining changes to the graph data structure; and
generating a heat map based on the changes.
